(19) United States
(12) Patent Application Publication
(10) Pub. No.: US 2025/0309750 A1
(43) Pub. Date: Oct. 2, 2025

(54) POWER CONVERSION CIRCUIT AND CONTROL METHOD THEREOF FOR ACHEIVING ZERO-VOLTAGE SWITCHING OF HIGH-SIDE TRANSISTOR

(71) Applicant: Richtek Technology Corporation, Zhubei City (TW)

(72) Inventors: Ta-Yung YANG, Taoyuan City (TW); Kuo-Chi LIU, Hsinchu City (TW); Kun-Yu LIN, Zhubei City (TW)

(21) Appl. No.: 19/086,315

(22) Filed: Mar. 21, 2025

Related U.S. Application Data
(60) Provisional application No. 63/572,394, filed on Apr. 1, 2024.

(30) Foreign Application Priority Data
Nov. 5, 2024 (TW) 113142308

(51) Int. Cl. H02M 1/00; H02M 1/08; H02M 3/00; H02M 3/335

(52) U.S. Cl. CPC H02M 1/0058; H02M 1/08; H02M 3/01; H02M 3/33571

(57) ABSTRACT

A power conversion circuit includes a resonant capacitor, a transformer, a high-side transistor, a low-side transistor, and a control circuit. The resonant capacitor is coupled to the switch node. The transformer includes a primary coil coupled to the resonant capacitor and a secondary coil. The high-side transistor and the low-side transistor couples the input voltage and the ground to the switch node. The control circuit generates a first signal in response to the high-side transistor being turned on, generates a second signal in response to the high-side transistor and the low-side transistor being both turned off, and generates a third signal by comparing the second signal with a voltage threshold corresponding to the first signal. The control circuit adjusts the on-time of the low-side transistor based on the third signal, so that the high-side transistor achieves zero-voltage switching.

### CROSS REFERENCE TO RELATED APPLICATIONS

This application claims the benefit of U.S. Provisional Application No. 63/572,394, filed on Apr. 1, 2024, the entirety of which is incorporated by reference herein.

This application claims priority of Taiwan Patent Application No. 113142308, filed on Nov. 5, 2024, the entirety of which is incorporated by reference herein.

### BACKGROUND OF THE INVENTION

### Field of the Invention

The disclosure is generally related to a power conversion circuit and a control method thereof, and more particularly it is related to a power conversion circuit and a control method thereof, in which a high-side transistor achieves zero-voltage switching.

### Description of the Related Art

With the continuous development of portable electronic devices, the current trend being seen in the development of power conversion circuits is the same as that seen in the development of most power products, which is towards high efficiency, high power density, high reliability, and low cost. Since resonant power conversion circuits (which including LLC resonant power conversion circuits, flyback power conversion circuits, and others) are high-efficiency and high-power density power conversion circuits, resonant power conversion circuits are gradually becoming the favorite power conversion circuits used in portable electronic devices.

The high efficiency of resonant power conversion circuits can mainly be attributed to resonance and zero-voltage switching (ZVS). In general, however, a resonant power conversion circuit often generates more power loss in order to achieve zero-voltage switching. Therefore, it is necessary to optimize the resonant power conversion circuit so that it can achieve high-efficiency zero-voltage switching under heavy-load and light-load conditions.

### BRIEF SUMMARY OF THE INVENTION

The present invention proposes a resonant power conversion circuit and a control method thereof. By adjusting the conduction time of the low-side transistor to adjust the circulating current of the transformer, not only can zero-voltage switching of the high-side transistor be achieved, but also the conversion efficiency of the resonant power conversion circuit can be improved at the same time.

In an embodiment, a power conversion circuit comprises a resonant capacitor, a transformer, a high-side transistor, a low-side transistor, a first voltage-dividing circuit, and a control circuit. The resonant capacitor is coupled between a switch node and a resonant node. The transformer comprises a primary coil and a secondary coil, wherein a terminal of the primary coil is coupled to the resonant node. The high-side transistor provides an input voltage to the switch node based on a high-side driving signal. The low-side transistor couples the switch node to a ground. The first voltage-dividing circuit divides the voltage of the switch node to generate a switching signal. The control circuit generates a first signal by using the switching signal in response to the high-side driving signal being enabled. The control circuit generates a second signal by using the switching signal in response to the low-side driving signal being disabled and the high-side transistor being turned off. The control circuit compares the second signal with the voltage threshold value to generate a third signal. The voltage threshold corresponds to the first signal. The control circuit charges and discharges the resonant capacitor and the transformer using the high-side driving signal and the low-side driving signal, so that the secondary coil generates the output voltage of the power conversion circuit. The control circuit adjusts a pulse width of the low-side driving signal based on the third signal, so that the high-side transistor achieves zero-voltage switching.

According to an embodiment of the present invention, the power conversion circuit further comprises a level-shift circuit. When the second signal exceeds the voltage threshold, the level-shift circuit shifts a voltage level of the high-side driving signal to turn on the high-side transistor.

According to an embodiment of the present invention, the control circuit further comprises a sample-and-hold circuit. The sample-and-hold circuit is configured to sample the switching signal to generate the first signal. A voltage level of the first signal is related to an input voltage of the power conversion circuit.

According to an embodiment of the present invention, the control circuit further comprises an up/down counter. The up/down counter adjusts the pulse width of the low-side driving signal based on the first signal and the second signal.

According to an embodiment of the present invention, the control circuit generates an off-time voltage based on a period from the low-side driving signal being disabled to the high-side driving signal being enabled. The control circuit generates a threshold voltage based on a predetermined time threshold. The control circuit adjusts a pulse width of the low-side driving signal so that the off-time voltage is equal to the threshold voltage.

According to an embodiment of the present invention, the control circuit determines the maximum allowable time from the low-side driving signal being disabled to the high-side driving signal being enabled based on the longest off-time signal.

According to an embodiment of the present invention, the control circuit comprises a volt-second circuit. The volt-second circuit generates the low-side driving signal based on an on-time of the high-side transistor, a voltage across the primary coil, and the output voltage.

According to an embodiment of the present invention, the control circuit turns on the low-side transistor with the low-side driving signal to generate a circulating current. The circulating current is configured to achieve zero-voltage switching of the high-side transistor.

According to an embodiment of the present invention, the predetermined time threshold is related to an optimal circulating current generated by the low-side transistor. The optimal circulating current is configured to achieve zero-voltage switching of the high-side transistor and improve the efficiency of the power conversion circuit at the same time.

According to an embodiment of the present invention, when a period corresponding to the off-time voltage exceeds the predetermined time threshold, the control circuit increases the pulse width of the low-side driving signal in the next cycle. When the period corresponding to the off-time voltage does not exceed the predetermined time threshold, the control circuit reduces the pulse width of the low-side driving signal in the next cycle.

According to an embodiment of the present invention, when the second signal is less than the voltage threshold, the control circuit increases the pulse width of the low-side driving signal. When the second signal is not less than the voltage threshold, the control circuit shortens the pulse width of the low-side driving signal.

In another embodiment, a control method for controlling a power conversion circuit is provided. The power conversion comprises a resonant capacitor coupled between a switch node and a resonant node, a transformer comprising a primary coil and a secondary coil, a high-side transistor providing an input voltage to the switch node, and a low-side transistor coupling the switch node to a ground. A terminal of the primary coil is coupled to the resonant node. The high-side transistor and the low-side transistor are driven to generate a switching signal corresponding to the switch node and an output voltage of the power conversion circuit at the secondary coil. The control method comprises the following steps. A voltage threshold is generated by using the switching signal in response to the high-side transistor being turned on. The high-side transistor is turned on in response to the switching signal exceeding the voltage threshold and the high-side transistor and the low-side transistor both being turned off. The switching signal is compared with the voltage threshold to adjust an on-time of the low-side transistor, so that the high-side transistor achieves zero-voltage switching.

According to an embodiment of the present invention, the step of generating the voltage threshold by using the switching signal in response to the high-side transistor being turned on comprises the following steps. The switching signal is sampled to generate a first signal using a sample-and-hold circuit. The first signal is divided to generate the voltage threshold. A voltage level of the first signal is related to the input voltage of the power conversion circuit.

According to an embodiment of the present invention, the control method further comprises the following steps. An off-time voltage is generated based on a period from the low-side transistor being turned off to the high-side transistor being turned on. A threshold voltage is generated based on a predetermined time threshold. An on-time of the low-side transistor is adjusted, so that the off-time voltage is equal to the threshold voltage. According to an embodiment of the present invention, the control method further comprises the following steps. A maximum allowable time from the low-side transistor being turned off to the high-side transistor being turned on is determined based on a longest off-time signal.

According to an embodiment of the present invention, the control method further comprises the following steps. The low-side transistor is divided based on an on-time of the high-side transistor, a voltage across the primary coil, and the output voltage. When the low-side transistor is turned on, a circulating current is generated. The circulating current is configured to achieve zero-voltage switching of the high-side transistor.

According to an embodiment of the present invention, the predetermined time threshold is related to an optimal circulating current generated by the low-side transistor. The optimal circulating current is configured to achieve zero-voltage switching of the high-side transistor and improve the efficiency of the power conversion circuit at the same time.

According to an embodiment of the present invention, the control method further comprises the following steps. When a period corresponding to the off-time voltage exceeds the predetermined time threshold, the on-time of the low-side transistor is increased in the next cycle. When the period corresponding to the off-time voltage does not exceed the predetermined time threshold, the on-time of the low-side transistor is reduced in the next cycle.

According to an embodiment of the present invention, the step of comparing the switching signal with the voltage threshold to adjust the on-time of the low-side transistor further comprises the following steps. When the switching signal exceeds the voltage threshold, the on-time of the low-side transistor is increased in next cycle. When the switching signal does not exceed the voltage threshold, the on-time of the low-side transistor is reduced in next cycle.

According to an embodiment of the present invention, the power conversion circuit is an asynchronous half-bridge flyback power converter.

According to another embodiment of the present invention, the power conversion circuit is a resonant power converter.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a schematic diagram showing a power conversion circuit in accordance with an embodiment of the present invention;

FIG. 2 is a schematic diagram showing a first circuit in accordance with an embodiment of the present invention;

FIG. 3 is a schematic diagram showing a second circuit in accordance with an embodiment of the present invention;

FIG. 4 is a schematic diagram showing a volt-second circuit in accordance with an embodiment of the present invention;

FIG. 5 is a schematic diagram showing a third circuit in accordance with an embodiment of the present invention;

FIG. 6 is a waveform diagram showing the volt-second circuit and the third circuit in accordance with an embodiment of the present invention;

FIG. 7 is a schematic diagram showing an adjustment circuit in accordance with an embodiment of the present invention; and

FIG. 8 is a flow chart showing a control method in accordance with an embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/−20% of the stated value, more typically a range of +/−10%, +/−5%, +/−3%, +/−2%, +/−1% or +/−0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

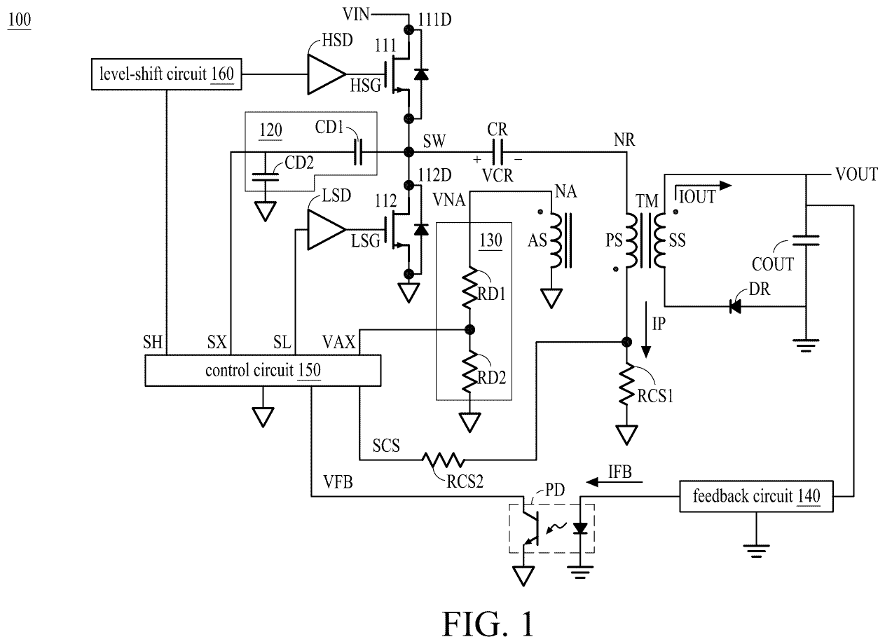

FIG. 1 is a schematic diagram showing a power conversion circuit in accordance with an embodiment of the present invention. As shown in FIG. 1, a power conversion circuit 100 includes a high-side transistor 111, a low-side transistor 112, a first voltage-dividing circuit 120, a resonant capacitor CR, a transformer TM, a rectifier element DR, an output capacitor COUT, a second voltage-dividing circuit 130, a first current detection resistor RC1, and a second current detection resistor RC2.

The high-side transistor 111 provides the input voltage VIN to the switch node SW based on the high-side gate driving signal HSG. According to an embodiment of the present invention, the high-side transistor 111 includes a high-side parasitic diode 111D, where the high-side parasitic diode 111D is coupled between the switch node SW and the input voltage VIN. The low-side transistor 112 couples the switch node SW to the ground terminal based on the low-side gate driving signal LSG. According to an embodiment of the present invention, the low-side transistor 112 includes a low-side parasitic diode 112D, where the low-side parasitic diode 112D is coupled between the switch node SW and the ground.

The first voltage-dividing circuit 120 includes a first voltage-dividing capacitor CD1 and a second voltage-dividing capacitor CD2, which are used to divide the voltage of the switch node SW to generate the switching signal SX. The resonant capacitor CR is coupled between the switch node SW and the resonant node NR, and a resonant voltage VCR is generated across the resonant capacitor CR. The transformer TM includes a primary winding PS, a secondary winding SS, and an auxiliary winding AS. The primary coil PS is coupled to the resonant node NR.

The output current IOUT generated by the secondary winding SS charges the output capacitor COUT through the rectifier element DR, thereby generating an output voltage VOUT. The auxiliary coil AS is coupled between an auxiliary node NA and the ground, and generates an auxiliary coil voltage VNA at the auxiliary node NA. The second voltage-dividing circuit 130 includes a first voltage-dividing resistor RD1 and a second voltage-dividing resistor RD2 for dividing the auxiliary coil voltage VNA to generate an auxiliary voltage VAX.

According to some embodiments of the present invention, the auxiliary voltage VAX is the output voltage VOUT multiplied by a ratio. According to an embodiment of the present invention, the auxiliary coil voltage VNA can be made equal to the output voltage VOUT by adjusting the turns ratio of the auxiliary coil AS and the secondary coil SS. In addition, the second voltage-dividing circuit 130 is used to multiply the auxiliary coil voltage VNA by n times, so the auxiliary voltage VAX is equal to the output voltage VOUT multiplied by n times, where n is less than 1 and greater than 0.

The first current detection resistor RC1 is coupled between the primary coil PS and the ground to detect the primary current IP flowing through the resonant capacitor CR and the primary coil PS. The second current detection resistor RC2 converts the cross voltage of the first current detection resistor RC1 into a current detection signal SCS.

As shown in FIG. 1, the power conversion circuit 100 further includes a feedback circuit 140, an optical coupling device PD, a control circuit 150, a level-shift circuit 160, a high-side driving circuit HSD, and a low-side driving circuit LSD. The feedback circuit 140 is used to convert the output voltage VOUT into a feedback current IFB, and the optical coupling device PD is used to convert the feedback current IFB into a feedback voltage VFB. The control circuit 150 generates a high-side driving signal SH and a low-side driving signal SL based on the feedback voltage VFB, the current detection signal SCS, the auxiliary voltage VAX, and the switching signal SX.

The level-shift circuit 160 is used to shift the voltage level of the high-side driving signal SH to the input voltage VIN. The high-side driving circuit HSD generates a high-side gate driving signal HSG based on the shifted signal to drive the high-side transistor 111. The low-side driving circuit LSD generates a low-side gate driving signal LSG based on the low-side driving signal SL to drive the low-side transistor 112.

According to one embodiment of the present invention, the power conversion circuit 100 can be an asynchronous half-bridge flyback power converter. According to another embodiment of the present invention, the power conversion circuit 100 may be a resonant power converter.

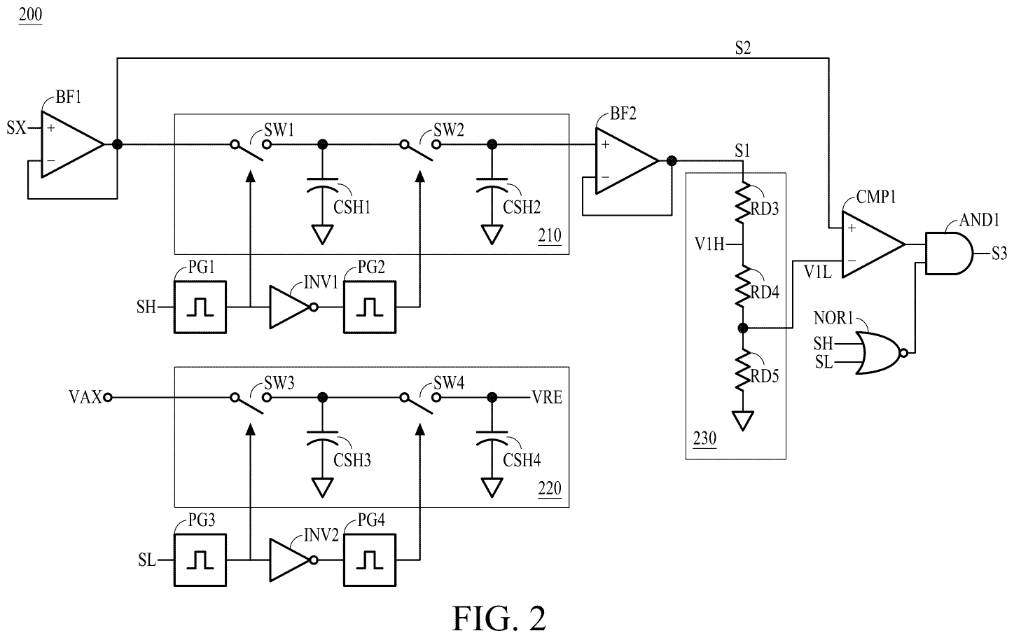

FIG. 2 is a schematic diagram showing a first circuit in accordance with an embodiment of the present invention. According to an embodiment of the present invention, the control circuit 150 of FIG. 1 includes a first circuit 200. As shown in FIG. 2, the first circuit 200 includes a first buffer BF1, a first sample-and-hold circuit 210, a first pulse generator PG1, a first inverter INV1, a second pulse generator PG2, a second buffer BF2, a third voltage-dividing circuit 230, a first comparator CMP1, a first NOR gate NOR1, and a first AND gate AND1.

The first buffer BF1 receives the switching signal SX and generates the second signal S2. According to an embodiment of the present invention, the first buffer BF1 generates the second signal S2 in order to increase the current driving capability of the switching signal SX. In other words, the second signal S2 is equal to the switching signal SX. The first sample-and-hold circuit 210 includes a first switch SW1, a first hold capacitor CSH1, a second switch SW2, and a second hold capacitor CSH2.

When the high-side driving signal SH is in the enabled state, the first pulse generator PG1 generates a positive pulse to turn on the first switch SW1, so that the first buffer BF1 charges the first hold capacitor CSH1. When the positive pulse generated by the pulse generator PG1 ends, the second switch SW2 is turned on through the first inverter INV1 and the second pulse generator PG2, so that the charge stored in the first hold capacitor CSH1 charges the second hold capacitor CSH2.

The second buffer BF2 generates the first signal S1 based on the cross voltage of the second hold capacitor CSH2. According to an embodiment of the present invention, the first signal S1 is equivalent to the maximum value of the switching signal SX when the high-side transistor 111 is turned on. According to an embodiment of the present invention, the first signal S1 is related to the input voltage VIN. The third voltage-dividing circuit 230 includes a third voltage-dividing resistor RD3, a fourth voltage-dividing resistor RD4, and a fifth voltage-dividing resistor RD5 for dividing the first signal S1 to generate a first high voltage V1H and a first low voltage V1L, where the first high voltage V1H is higher than the first low voltage V1L.

The first comparator CMP1 compares the second signal S2 with the first low voltage V1L, and the first NOR gate NOR1 performs a logic NOR operation on the high-side driving signal SH and the low-side driving signal SL. The first AND gate AND1 performs a logic AND operation on the output signal of the first comparator CMP1 and the output signal of the first NOR gate NOR1 to generate a third signal S3.

In other words, when the high-side transistor 111 and the low-side transistor 112 in FIG. 1 are both turned off and the second signal S2 exceeds the first low voltage V1L, the third signal S3 is in an enabled state. According to some embodiments of the present invention, the control circuit 150 of FIG. 1 adjusts the pulse width of the low-side driving signal SL (i.e., the on-time of the low-side transistor 112) based on the third signal S3 to achieve zero-voltage switching of the high-side transistor 111.

As shown in FIG. 2, the first circuit 200 further includes a second sample-and-hold circuit 220, a third pulse generator PG3, a second inverter INV2, and a fourth pulse generator PG4. The second sample-and-hold circuit 220 includes a third switch SW3, a third hold capacitor CSH3, a fourth switch SW4, and a fourth hold capacitor CSH4.

When the low-side driving signal SL is in the enabled state, the positive pulse generated by the third pulse generator PG3 turns on the third switch SW3, so that the auxiliary voltage VAX charges the third hold capacitor CSH3. When the positive pulse generated by the third pulse generator PG3 ends, the second inverter INV2 and the fourth pulse generator PG4 then generate a positive pulse to turn on the fourth switch SW4, so that the charge of the third hold capacitor CSH3 charges the fourth hold capacitor CSH4 to generate the reflected voltage VRE.

According to one embodiment of the present invention, the auxiliary voltage VAX is the output voltage VOUT multiplied by a ratio, and the reflected voltage VRE is equal to the auxiliary voltage VAX, so the reflected voltage VRE is equal to the output voltage VOUT multiplied by a ratio. In other words, the reflected voltage VRE is proportional to the output voltage VOUT.

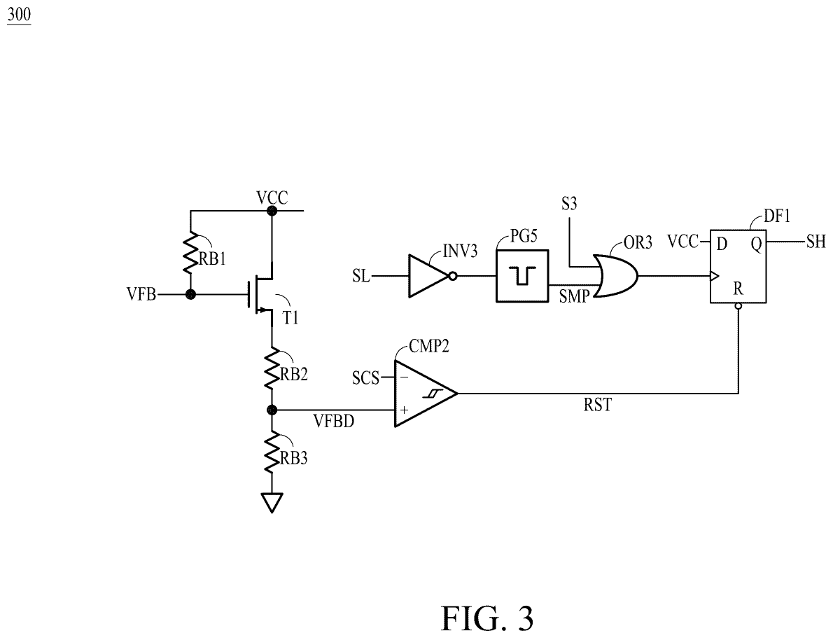

IG. 3 is a schematic diagram showing a second circuit in accordance with an embodiment of the present invention. According to an embodiment of the present invention, the control circuit 150 of FIG. 1 includes a second circuit 300. As shown in FIG. 3, the second circuit 300 includes a first transistor T1, a first bias resistor RB1, a second bias resistor RB2, a third bias resistor RB3, a second comparator CMP2, a third inverter INV3, a fifth pulse generator PG5, a first OR gate OR1, and a first D-type flip-flop DF1.

The drain terminal of the first transistor T1 receives the supply voltage VCC, the gate terminal of the first transistor T1 receives the feedback voltage VFB, and the first bias resistor RB1 is coupled between the drain terminal and the gate terminal of the first transistor T1. The second bias resistor RB2 and the third bias resistor RB3 are connected in series between the source terminal of the first transistor T1 and the ground to generate a divided feedback voltage VFBD.

The second comparator CMP2 compares the divided feedback voltage VFBD and the current detection signal SCS to generate a reset signal RST. The third inverter INV3 inverts the low-side driving signal SL to trigger the fifth pulse generator PG5 to generate the longest off-time signal SMP with a negative pulse. According to an embodiment of the present invention, the width of the negative pulse of the longest off-time signal SMP is used to determine the maximum allowable time from when the low-side transistor 112 is turned off to when the high-side transistor 111 is turned on.

The first OR gate OR1 is used to perform a logic OR operation on the third signal S3 and the longest off-time signal SMP to trigger the first D-type flip-flop DF1. The first D-type flip-flop DF1 outputs the supply voltage VCC as the high-side driving signal SH based on the output of the first OR gate OR1 being a rising edge, so that the high-side transistor 111 is turned on. When the reset signal RST is at a low logic level, the first D-type flip-flop DF1 resets the high-side driving signal SH to a low logic level, i.e., turning off the high-side transistor 111.

As shown in FIG. 3, the high-side driving signal SH is generated based on the third signal S3, and as shown in FIG. 2, the third signal S3 is enabled based on the second signal S2 exceeding the first low voltage V1L (and both the high-side driving signal SH and the low-side driving signal SL are in a disabled state). In other words, when both the high-side transistor 111 and the low-side transistor 112 are off and the voltage of the switch node SW also exceeds a threshold value, the high-side transistor 111 is turned on.

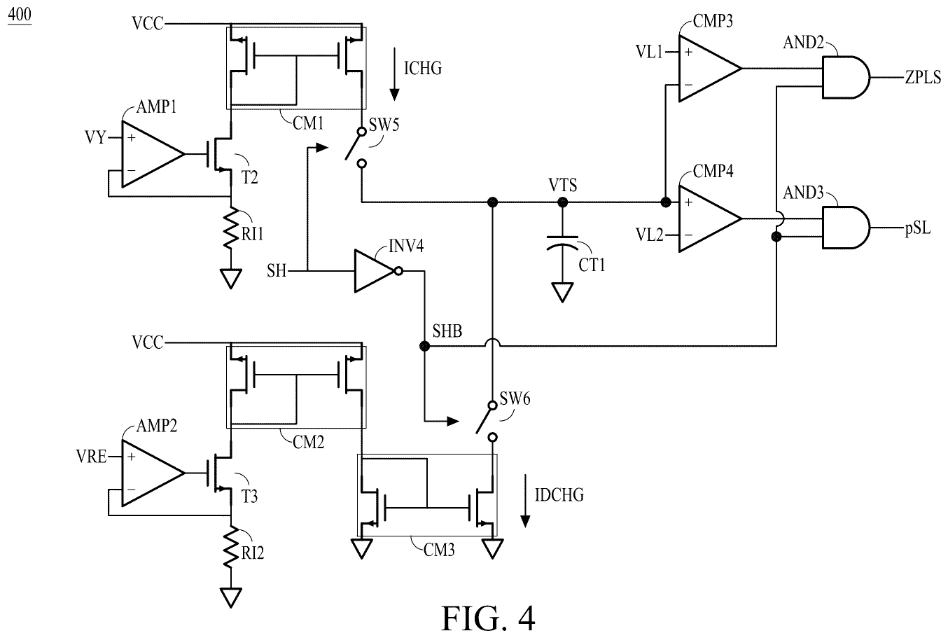

FIG. 4 is a schematic diagram showing a volt-second circuit in accordance with an embodiment of the present invention. According to one embodiment of the present invention, the control circuit 150 of FIG. 1 includes a volt-second circuit 400. As shown in FIG. 4, the volt-second circuit 400 includes a first amplifier AMP1, a second transistor T2, a first current resistor RI1, a first current mirror CM1, a second amplifier AMP2, a third transistor T3, a second current resistor RI2, a second current mirror CM2, and a third current mirror CM3.

The first amplifier AMP1, the first current resistor RI1, and the first current mirror CM1 are used to generate a charging current ICHG based on the magnetizing voltage VY. According to some embodiments of the present invention, when the high-side transistor 111 in FIG. 1 is turned on (i.e., the high-side driving signal SH is enabled and the transformer TM is magnetized), the magnetizing voltage VY is related to the voltage across the primary winding PS, where the magnetizing voltage VY is equal to the first signal S1 minus the reflected voltage VRE. According to some embodiments of the present invention, the first signal S1 is related to the input voltage VIN. According to some embodiments of the present invention, the first signal S1 may be considered to be equal to the input voltage VIN.

According to some embodiments of the present invention, when the transformer TM of FIG. 1 is demagnetized (i.e., the low-side transistor 112 is turned on), the resonant voltage VCR is equal to the cross-voltage of the primary coil PS, and the resonant voltage VCR when the transformer TM is demagnetized is approximately equal to the resonant voltage VCR when the transformer TM is magnetized (i.e., the high-side transistor 111 is turned on). In other words, the reflected voltage VRE is equal to the resonant voltage VCR, and the resonant voltage VCR during demagnetization of the transformer TM and that during magnetization of the transformer TM are substantially equal, so the first signal S1 minus the reflected voltage VRE can represent the voltage across the primary coil PS when the transformer TM is magnetized. Therefore, the charging current ICHG is generated based on the voltage across the primary winding PS when the transformer TM is magnetized (i.e., the high-side transistor 111 is turned on).

The second amplifier AMP2, the third transistor T3, the second current resistor RI2, the second current mirror CM2, and the third current mirror CM3 are used to generate a discharging current IDCHG based on the reflected voltage VRE. As shown in FIG. 4, the volt-second circuit 400 further includes a fifth switch SW5, a fourth inverter INV4, a sixth switch SW6, a first time capacitor CT1, a third comparator CMP3, a fourth comparator CMP4, a second AND gate AND2, and a third AND gate AND3.

The fourth inverter INV4 inverts the high-side driving signal SH to generate an inverted high-side driving signal SHB. When the high-side driving signal SH is enabled (i.e., the high-side transistor 111 is turned on), the fifth switch SW5 is turned on, so that the charging current ICHG charges the first time capacitor CT1 to generate the time voltage VTS. When the high-side driving signal SH is disabled (i.e., the high-side transistor 111 is turned off), the inverted high-side driving signal SHB is enabled to turn on the sixth switch SW6, so that the discharging current IDCHG discharges the first time capacitor CT1 to reduce the time voltage VTS.

The third comparator CMP3 compares the first threshold value VL1 with a time voltage VTS, and the fourth comparator CMP4 compares the time voltage VTS with the second threshold value VL2. The second AND gate AND2 performs a logic AND operation on the output of the third comparator CMP3 and the inverted high-side driving signal SHB to generate a trigger signal ZPLS. The third AND gate AND3 performs a logic AND operation on the output of the fourth comparator CMP4 and the inverted high-side driving signal SHB to generate the preceding low-side driving signal pSL. According to an embodiment of the present invention, the first threshold value VL1 is greater than the second threshold value VL2.

According to some embodiments of the present invention, when the high-side driving signal SH is disabled (i.e., the inverted high-side driving signal SHB is enabled and the high-side transistor 111 is turned off) and the time voltage VT drops to less than the first threshold value VL1, the trigger signal ZPLS is enabled. According to some embodiments of the present invention, when the high-side driving signal SH is disabled, the preceding low-side driving signal pSL is enabled; when the time voltage VTS further drops below the second critical line value VL2, the preceding low-side driving signal pSL is disabled. According to some embodiments of the present invention, the preceding low-side driving signal pSL is configured to generate the low-side driving signal SL, and is related to the demagnetization time of the transformer TM.

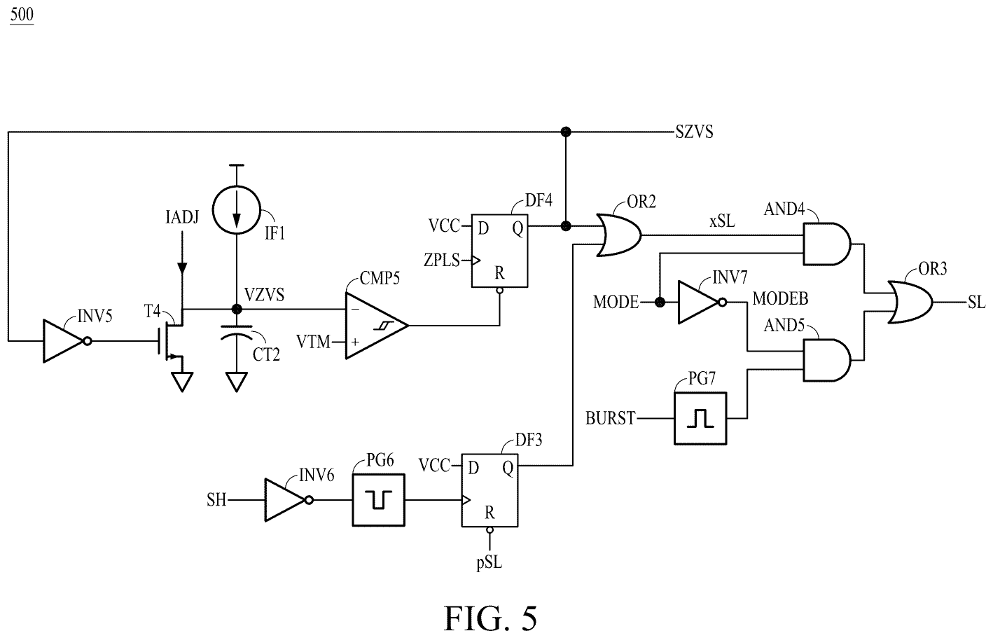

FIG. 5 is a schematic diagram showing a third circuit in accordance with an embodiment of the present invention. According to an embodiment of the present invention, the control circuit 150 of FIG. 1 includes a third circuit 500. As shown in FIG. 5, the third circuit 500 includes a second D-type flip-flop DF2, a fifth inverter INV5, a fourth transistor T4, a first current source IF1, a second time capacitor CT2, a fifth comparator CMP5, a sixth inverter INV6, a sixth pulse generator PG6, a third D-type flip-flop DF3, and a second OR gate OR2.

The second D-type flip-flop DF2 outputs the supply voltage VCC as a zero-voltage switching signal SZVS based on the rising edge of the trigger signal ZPLS, and turns off the fourth transistor T4 through the fifth inverter INV5, so that the adjustment current IADJ and the current of the first current source IF1 charge the second time capacitor CT2 to generate a zero-voltage switching voltage VZVS. The fifth comparator CMP5 compares the zero-voltage switching voltage VZVS with a time threshold voltage VTM to disable the second D-type flip-flop DF2.

When the zero-voltage switching voltage VZVS exceeds the time threshold voltage VTM, the fifth comparator CMP5 resets the second D-type flip-flop DF2, thereby disabling the zero-voltage switching signal SZVS. The fourth transistor T4 is also turned on when the zero-voltage switching signal SZVS is disabled, and discharges the second time capacitor CT2. In other words, the first current source IF1, the adjustment current IADJ and the second time capacitor CT2 are configured to determine the positive pulse width of the zero-voltage switching signal SZVS.

The sixth inverter INV6 triggers the sixth pulse generator PG6 to generate a negative pulse based on the disabled high-side drive signal SH. The third D-type flip-flop DF3 outputs the supply voltage VCC based on the rising edge generated by the sixth pulse generator PG6. In addition, the disabled preceding low-side driving signal pSL is used to reset the output signal of the third D-type flip-flop DF3. The second OR gate OR2 performs a logic OR operation on the zero-voltage switching signal SZVS and the output signal of the third D-type flip-flop DF3 to generate an expected low-side driving signal xSL.

As shown in FIG. 5, the third circuit 500 further includes a fourth AND gate AND4, a seventh inverter INV7, a seventh pulse generator PG7, a fifth AND gate AND5, and a third OR gate OR3. According to an embodiment of the present invention, when the mode signal MODE is at a high logic level, the expected low-side driving signal xSL is output as the low-side driving signal SL via the fourth AND gate AND4 and the third OR gate OR.

According to another embodiment of the present invention, when the mode signal MODE is at a low logic level, the seventh inverter INV7 inverts the mode signal MODE at the low logic level to generate an inverted mode signal MODEB. The enabled burst signal BURST triggers the seventh pulse generator PG7, so that the seventh pulse generator PG7 generates a positive pulse. The fifth AND gate AND5 performs a logic AND operation on the inverted mode signal MODEB and the positive pulse generated by the seventh pulse generator PG7, and the output signal of the fifth AND gate AND5 is output as the low-side driving signal SL through the third OR gate OR3.

In other words, when the mode signal MODE is at a high logic level, the expected low-side driving signal xSL is output as the low-side driving signal SL. When the mode signal MODE is at a low logic level, the enabled burst signal BURST triggers the positive pulse of the seventh pulse generator PG7 to temporarily enable the low-side driving signal SL.

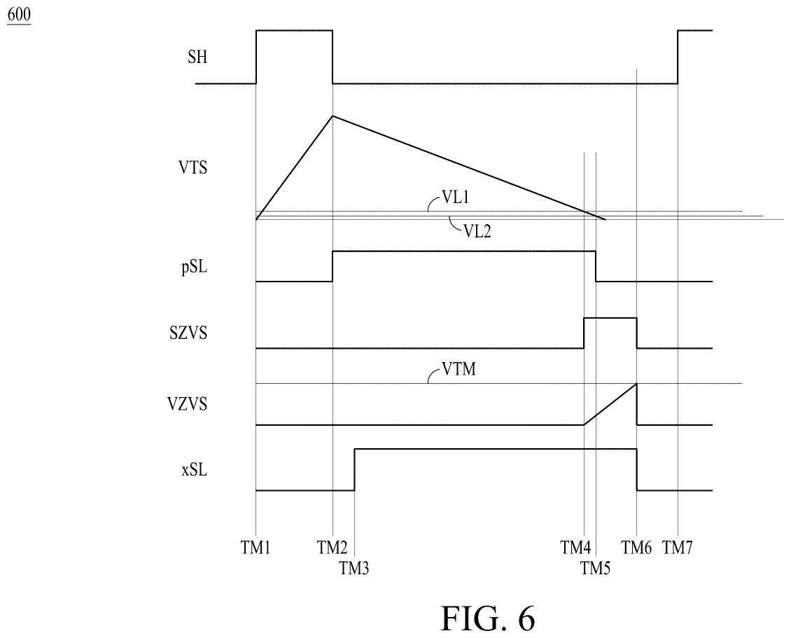

FIG. 6 is a waveform diagram showing the volt-second circuit and the third circuit in accordance with an embodiment of the present invention. The waveform diagram 600 will be described below in detail with reference to the power conversion circuit 100 of FIG. 1, the volt-second circuit 400 of FIG. 4, and the third circuit 500 of FIG. 5.

As shown in FIG. 6, the period from the first time point TM1 to the second time point TM2 is the period that the high-side driving signal SH is enabled. In other words, between the first time point TM1 and the second time point TM2, the high-side transistor 111 is turned on. As shown in FIG. 4, when the high-side driving signal SH is enabled, the charging current ICHG charges the first time capacitor CT1, so that the time voltage VTS gradually increases, and the rising slope is determined by the charging current ICHG. The period from the second time point TM2 to the third time point TM3 is a dead time, and is determined by the width of the negative pulse of the sixth pulse generator PG6 of FIG. 5. According to some embodiments of the present invention, the dead time from the second time point TM2 to the third time point TM3 is used to achieve zero-voltage switching of the low-side transistor 112.

As shown in FIG. 4, at the second time point TM2 in FIG. 6, the high-side driving signal SH is disabled, and the voltage VTS at the second time point TM2 is maximum, so that the output signal of the fourth comparator CMP4 enables the preceding low-side driving signal pSL. As shown in FIG. 5, when the preceding low-side drive signal pSL is enabled, the third D-type flip-flop DF3 enables the expected low-side drive signal xSL and the low-side drive signal SL (i.e., turns on the low-side transistor 112) based on the rising edge after the negative pulse generated by the sixth pulse generator PG6. As shown in FIG. 6, after the second time point TM2, the time voltage VTS gradually decreases, and the decreasing slope is determined by the discharge current IDCHG in FIG. 5.

As shown in FIG. 6, at the fourth time point TM4, the time voltage VTS drops below the first threshold value VL1. As shown in FIG. 4, when the time voltage VTS drops below the first threshold value VL1, the trigger signal ZPLS is converted from a low logic level to a high logic level, thereby triggering the second D-type flip-flop DF2 in FIG. 5, so that the zero-voltage switching signal SZVS is enabled (i.e., a high logic level). Furthermore, the adjustment current IADJ and the first fixed current source IF1 charge the second time capacitor CT2, so that the zero-voltage switching voltage VZVS increases.

As shown in FIG. 6, at the fifth time point TM5, the time voltage VTS drops below the second threshold value VL2. As shown in FIG. 4, when the time voltage VTS drops below the second threshold value VL2, the preceding low-side driving signal pSL is disabled, thereby disabling the third D-type flip-flop DF3 in FIG. 5. According to an embodiment of the present invention, when the high-side driving signal SH is disabled and the time voltage VTS drops below the second threshold voltage VL2, the preceding low-side driving signal pSL is disabled. As shown in FIG. 5, since the zero-voltage switching signal SZVS is still in the enabled state, the low-side driving signal xSL and the low-side driving signal SL are expected to remain in the enabled state.

As shown in FIG. 5, the second time capacitor CT2 starts to charge at the fourth time point TM4 in FIG. 6 since the trigger signal ZPLS enables the zero-voltage switching signal SZVS, so that the zero-voltage switching voltage VZVS continues to increase. At the sixth time point TM6, the zero-voltage switching voltage VZVS exceeds the time threshold voltage VTM. As shown in FIG. 5, when the zero-voltage switching voltage VZVS exceeds the time threshold voltage VTM, the fifth comparator CMP5 resets the second D-type flip-flop DF2 to disable the zero-voltage switching signal SZVS, thereby disabling the expected low-side driving signal xSL and the low-side driving signal SL. In other words, at the sixth time point TM6, the low-side transistor 112 is turned off.

As shown in FIG. 6, the period from the sixth time point TM6 to the seventh time point TM7 is the period that both the high-side transistor 111 and the low-side transistor 112 are turned off. Furthermore, the length of the period from the sixth time point TM6 to the seventh time point TM7 is determined by the adjustment current IADJ, the first current source IF1, and the second time capacitor CT2, and the length of the period from the sixth time point TM6 to the seventh time point TM7 can be changed by adjusting the current IADJ. On the other hand, the adjustment current IADJ, the first current source IF1, and the second time capacitor CT2 can also determine the pulse width of the zero-voltage switching signal SZVS (i.e., the pulse width of the low-side driving signal SL).

According to one embodiment of the present invention, when the pulse width of the zero-voltage switching signal SZVS (that is, the pulse width of part of the low-side driving signal SL) is small, a smaller circulating current of the transformer TM will be generated, which may result in failure to achieve zero-voltage switching of the high-side transistor 111. According to another embodiment of the present invention, when the pulse width of the zero-voltage switching signal SZVS is larger, it can ensure that the high-side transistor 111 achieves zero-voltage switching, but it may also generate greater power loss. Therefore, it is necessary to optimize the pulse width of the zero-voltage switching signal SZVS (i.e., the pulse width of the low-side driving signal SL) to ensure that the high-side transistor achieves zero-voltage switching and also improves the conversion efficiency, especially under the light load condition.

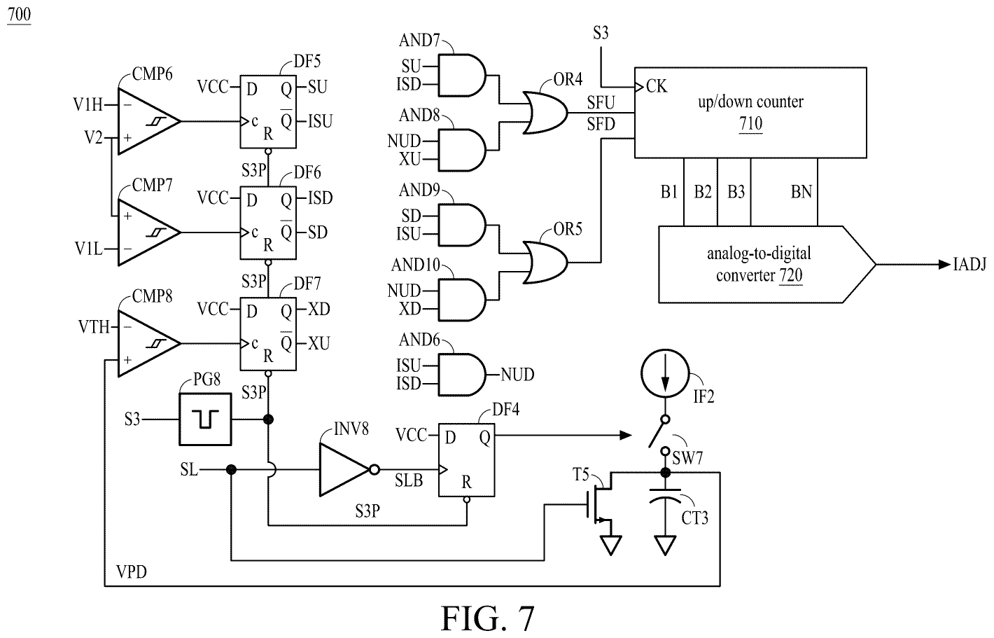

FIG. 7 is a schematic diagram showing an adjustment circuit in accordance with an embodiment of the present invention. According to one embodiment of the present invention, the control circuit 150 of FIG. 1 includes an adjustment circuit 700. As shown in FIG. 7, the adjustment circuit 700 includes an eighth inverter INV8, a fourth D-type flip-flop DF4, a seventh switch SW7, a fifth transistor T5, a second fixed current IF2, a third time capacitor CT3, and an eighth pulse generator PG8.

The eighth inverter INV8 inverts the low-side drive signal SL to generate an inverted low-side drive signal SLB. The fourth D-type flip-flop DF4 outputs the supply voltage VCC to turn on the seventh switch SW7 based on the rising edge of the inverted low-side driving signal SLB. The fifth transistor T5 is turned off based on the low-side driving signal SL, so that the second fixed current IF2 charges the third time capacitor CT3 through the seventh switch SW7 to generate the off-time voltage VPD. The eighth pulse generator PG8 generates the negative pulse signal S3P based on the enabled third signal S3. When the negative pulse signal S3P is at a low logic level, the fourth D-type flip-flop DF4 is reset and the seventh switch SW7 is turned off. According to an embodiment of the present invention, the third signal S3 corresponds to the third signal S3 of FIG. 2.

As shown in FIG. 7, the adjustment circuit 700 further includes a sixth comparator CMP6, a fifth D-type flip-flop DF5, a seventh comparator CMP7, a sixth D-type flip-flop DF6, an eighth comparator CMP8, a seventh D-type flip-flop DF7, a sixth AND gate AND6, a seventh AND gate AND7, an eighth AND gate AND8, a fourth OR gate OR4, a ninth AND gate AND9, a tenth AND gate AND10, a fifth OR gate OR5, an up/down counter 710, and an analog-to-digital converter 720.

The sixth comparator CMP6 is used to compare the second signal S2 of FIG. 2 with the first high voltage VIH to trigger the fifth D-type flip-flop DF5 to generate an up signal SU and an inverted up signal ISU. The seventh comparator CMP7 is used for comparing the second signal S2 with the first low voltage V1L to trigger the sixth D-type flip-flop DF6 to generate the inverted down-count signal ISD and the down-count signal SD. The eighth comparator CMP8 compares the off-time voltage VPD and the threshold voltage VTH to trigger the seventh D-type flip-flop DF7 to generate the additional down-count signal XD and the additional up-count signal XU. In addition, when the negative pulse signal S3P is at a low logic level, the fifth D-type flip-flop DF5, the sixth D-type flip-flop DF6, and the seventh D-type flip-flop DF7 are reset.

The sixth AND gate AND6 generates a non-counting signal NUD based on the inverted up-count signal ISU and the inverted down-count signal ISD. The seventh AND gate AND7, the eighth AND gate AND8, and the fourth OR gate OR4 generate the final up-count signal SFU based on the up-count signal SU, the inverted down-count signal ISD, the non-counting signal NUD, and the additional up-count signal XU. The ninth AND gate AND9, the tenth AND gate AND10, and the fifth OR gate OR5 generate a final down-count signal SFD based on the down-count signal SD, the inverted up-count signal ISU, the un-count signal NUD, and the additional down-count signal XD.

The up/down counter 710 uses the third signal S3 as a clock, up-counts the digital codes B1, B2, . . . . BN based on the enabled final up signal SFU, and down-counts the digital codes B1, B2, . . . . BN based on the enabled final down signal SFD. The digital-to-analog converter 720 generates an adjustment current IADJ based on the digital codes B1, B2, . . . . BN. In other words, when the final up-count signal SFU is enabled and the final down-count signal SFD is disabled, the adjustment current IADJ is increased. When the final up-count signal SFU is disabled and the final down-count signal SFD is enabled, the adjustment current IADJ is reduced.

According to one embodiment of the present invention, when the second signal S2 is lower than the first low voltage V1L, the down-count signal SD and the inverted up-count signal ISU are both at a high logic level, so that the up/down counter 710 counts down based on the final down-count signal SFD, resulting in a decrease in the adjustment current IADJ and an increase in the on-time of the low-side transistor 112, thereby increasing the circulating current. According to another embodiment of the present invention, when the second signal S2 exceeds the first high voltage V1H, the up-count signal SU and the inverted down-count signal ISD are both at a high logic level, so that the up/down counter 710 counts up based on the final up-counting signal SFU, resulting in an increase in the adjustment current IADJ and shortening the on-time of the low-side transistor 112, thereby reducing the circulating current.

According to another embodiment of the present invention, when the second signal S2 is between the first high voltage V1H and the first low voltage V1L, the adjustment voltage IADJ is adjusted according to the length from the sixth time point TM6 to the seventh time point TM7 of FIG. 6. When the off-time voltage VPD exceeds the threshold voltage VTH (i.e., the period from the sixth time point TM6 to the seventh time point TM7 exceeds the predetermined time threshold corresponding to the threshold voltage VTH), the adjustment current IADJ is reduced to increase the on-time of the low-side transistor 112 and shorten the period from the sixth time point TM6 to the seventh time point TM7. According to some embodiments of the present invention, after the adjustment current IADJ is adjusted, the adjusted IADJ is used to adjust the pulse width of the low-side driving signal LS in the next cycle (i.e., the on-time of the low-side transistor 112 in the next cycle).

When the off-time voltage VPD does not exceed the threshold voltage VTH, the adjustment current IADJ is increased to shorten the on-time of the low-side transistor 112 and increase the period from the sixth time point TM6 to the seventh time point TM7. The circulating current is optimized by adjusting the adjustment current IADJ to optimize the on-time of the low-side transistor 112, thereby ensuring the zero-voltage switching of the high-side transistor 111 and also improving the conversion efficiency of the power conversion circuit 100. According to an embodiment of the present invention, when the circulating current reaches the optimal circulating current, the zero-voltage switching of the high-side transistor 111 can be achieved, and the efficiency of the power conversion circuit 100 can be improved at the same time.

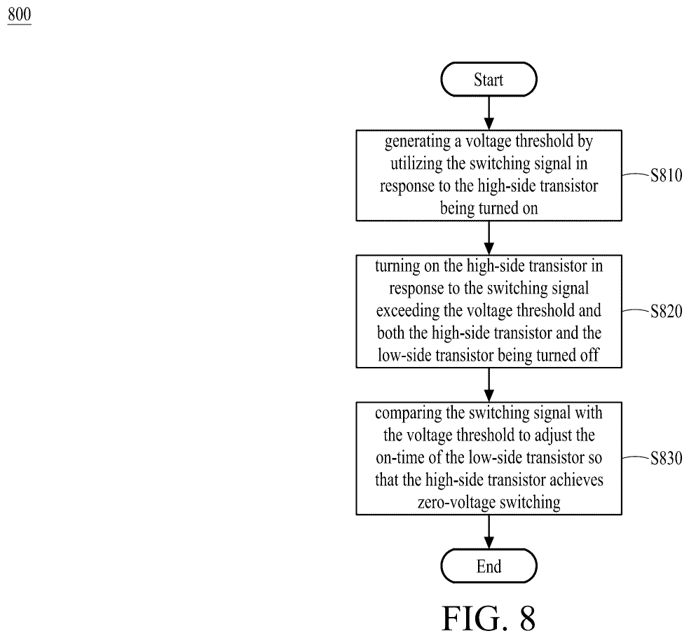

FIG. 8 is a flow chart showing a control method in accordance with an embodiment of the present invention. The following description of the control method 800 will be described in conjunction with FIGS. 1-7 for detailed explanation. First, in response to the high-side transistor 111 being turned on, a voltage threshold is generated by utilizing the switching signal SX (Step S810). As shown in FIG. 2, when the high-side transistor 111 is turned on, the high-side driving signal SH is enabled, thereby triggering the first sample-and-hold circuit 210 to sample the switching signal SX to generate a first signal S1, and utilizing the first signal S1 to generate a first low voltage V1L and a first high voltage V1H. According to an embodiment of the present invention, the voltage threshold of Step S810 corresponds to the first low voltage V1L.

Next, in response to the switching signal SX exceeding the voltage threshold and both the high-side transistor 111 and the low-side transistor 112 being turned off, the high-side transistor 111 is turned on (Step S820). As shown in FIG. 2, the second signal S2 is equal to the switching signal SX. When the second signal S2 exceeds the voltage threshold (i.e., the first low voltage V1L) and the high-side driving signal SH and the low-side driving signal SL are both disabled, the third signal S3 is enabled. As shown in FIG. 3, when the third signal S3 is enabled and the low-side driving signal SL is disabled, the first D-type flip-flop DF1 enables the high-side driving signal SH through the pulse width of the fifth pulse generator PG5.

Subsequently, the switching signal SX is compared with the voltage threshold to adjust the on-time of the low-side transistor 112 so that the high-side transistor 111 achieves zero-voltage switching (Step S830). As shown in FIG. 2, the second signal S2 is compared with the first low voltage V1L to generate a third signal S3. As shown in FIG. 7, the third signal S3 is used to adjust the adjustment current IADJ. As shown in FIG. 5 and FIG. 6, the adjustment current IADJ is used to adjust the rising speed of the zero-voltage switching voltage VZVS, thereby adjusting the enabling time of the low-side driving signal SL.

The present invention proposes a resonant power conversion circuit and a control method thereof. By adjusting the conduction time of the low-side transistor to adjust the circulating current of the transformer, not only can zero-voltage switching of the high-side transistor be achieved, but also the conversion efficiency of the resonant power conversion circuit can be improved at the same time.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A power conversion circuit, comprising:
a resonant capacitor, coupled between a switch node and a resonant node;
a transformer, comprising a primary coil and a secondary coil, wherein a terminal of the primary coil is coupled to the resonant node;
a high-side transistor, providing an input voltage to the switch node based on a high-side driving signal;
a low-side transistor, coupling the switch node to a ground;
a first voltage-dividing circuit, dividing a voltage of the switch node to generate a switching signal; and
a control circuit, generating a first signal by using the switching signal in response to the high-side driving signal being enabled, generating a second signal by using the switching signal in response to the low-side driving signal being disabled and the high-side transistor being turned off, and comparing the second signal with a voltage threshold value to generate a third signal;
wherein the voltage threshold corresponds to the first signal;
wherein the control circuit charges and discharges the resonant capacitor and the transformer using the high-side driving signal and the low-side driving signal, so that the secondary coil generates an output voltage of the power conversion circuit;
wherein the control circuit adjusts a pulse width of the low-side driving signal based on the third signal, so that the high-side transistor achieves zero-voltage switching.

2. The power conversion circuit as claimed in claim 1, further comprising:
a level-shift circuit, wherein when the second signal exceeds the voltage threshold, the level-shift circuit shifts a voltage level of the high-side driving signal to turn on the high-side transistor.

3. The power conversion circuit as claimed in claimed 1, wherein the control circuit further comprises:
a sample-and-hold circuit, configured to sample the switching signal to generate the first signal;
wherein a voltage level of the first signal is related to an input voltage of the power conversion circuit.

4. The power conversion circuit as claimed in claimed 1, wherein the control circuit further comprises:
an up/down counter, adjusting the pulse width of the low-side driving signal based on the first signal and the second signal.

5. The power conversion circuit as claimed in claimed 1, wherein the control circuit generates an off-time voltage based on a period from the low-side driving signal being disabled to the high-side driving signal being enabled;
wherein the control circuit generates a threshold voltage based on a predetermined time threshold;
wherein the control circuit adjusts the pulse width of the low-side driving signal so that the off-time voltage is equal to the threshold voltage.

6. The power conversion circuit as claimed in claim 5, wherein the control circuit determines a maximum allowable time from the low-side driving signal being disabled to the high-side driving signal being enabled based on a longest off-time signal.

7. The power conversion circuit as claimed in claim 5, wherein the control circuit comprises:
a volt-second circuit, generating the low-side driving signal based on an on-time of the high-side transistor, a voltage across the primary coil, and the output voltage.

8. The power conversion circuit as claimed in claim 7, wherein the control circuit turns on the low-side transistor with the low-side driving signal to generate a circulating current;
wherein the circulating current is configured to achieve zero-voltage switching of the high-side transistor.

9. The power conversion circuit as claimed in claim 8, wherein the predetermined time threshold is related to an optimal circulating current generated by the low-side transistor;
wherein the optimal circulating current is configured to achieve zero-voltage switching of the high-side transistor and improve efficiency of the power conversion circuit at the same time.

10. The power conversion circuit as claimed in claim 5, wherein when a period corresponding to the off-time voltage exceeds the predetermined time threshold, the control circuit increases the pulse width of the low-side driving signal in next cycle;
wherein when the period corresponding to the off-time voltage does not exceed the predetermined time threshold, the control circuit reduces the pulse width of the low-side driving signal in next cycle.

11. The power conversion circuit as claimed in claim 1, wherein when the second signal is less than the voltage threshold, the control circuit increases the pulse width of the low-side driving signal;
wherein when the second signal is not less than the voltage threshold, the control circuit shortens the pulse width of the low-side driving signal.

12. A control method for controlling a power conversion circuit, wherein the power conversion comprises a resonant capacitor coupled between a switch node and a resonant node, a transformer comprising a primary coil and a secondary coil, a high-side transistor providing an input voltage to the switch node, and a low-side transistor coupling the switch node to a ground, wherein a terminal of the primary coil is coupled to the resonant node, wherein the high-side transistor and the low-side transistor are driven to generate a switching signal corresponding to the switch node and an output voltage of the power conversion circuit at the secondary coil, wherein the control method comprises:
generating a voltage threshold by using the switching signal in response to the high-side transistor being turned on;
turning on the high-side transistor in response to the switching signal exceeding the voltage threshold and the high-side transistor and the low-side transistor both being turned off; and
comparing the switching signal with the voltage threshold to adjust an on-time of the low-side transistor, so that the high-side transistor achieves zero-voltage switching.

13. The control method as claimed in claim 12, wherein the step of generating the voltage threshold by using the switching signal in response to the high-side transistor being turned on comprises:
sampling the switching signal to generate a first signal using a sample-and-hold circuit; and
dividing the first signal to generate the voltage threshold;
wherein a voltage level of the first signal is related to an input voltage of the power conversion circuit.

14. The control method as claimed in claim 12, further comprising:
generating an off-time voltage based on a period from the low-side transistor being turned off to the high-side transistor being turned on;
generating a threshold voltage based on a predetermined time threshold; and
adjusting an on-time of the low-side transistor, so that the off-time voltage is equal to the threshold voltage.

15. The control method as claimed in claim 14, further comprising:
determining a maximum allowable time from the low-side transistor being turned off to the high-side transistor being turned on based on a longest off-time signal.

16. The control method as claimed in claim 14, further comprising:
driving the low-side transistor based on an on-time of the high-side transistor, a voltage across the primary coil, and the output voltage;
wherein when the low-side transistor is turned on, a circulating current is generated;
wherein the circulating current is configured to achieve zero-voltage switching of the high-side transistor.

17. The control method as claimed in claim 16, wherein the predetermined time threshold is related to an optimal circulating current generated by the low-side transistor;
wherein the optimal circulating current is configured to achieve zero-voltage switching of the high-side transistor and improve efficiency of the power conversion circuit at the same time.

18. The control method as claimed in claim 14, further comprising:
when a period corresponding to the off-time voltage exceeds the predetermined time threshold, increasing the on-time of the low-side transistor in next cycle; and
when the period corresponding to the off-time voltage does not exceed the predetermined time threshold, reducing the on-time of the low-side transistor in next cycle.

19. The control method as claimed in claim 12, wherein the step of comparing the switching signal with the voltage threshold to adjust the on-time of the low-side transistor further comprises:
when the switching signal exceeds the voltage threshold, increasing the on-time of the low-side transistor in next cycle; and
when the switching signal does not exceed the voltage threshold, reducing the on-time of the low-side transistor in next cycle.

20. The control method as claimed in claim 12, wherein the power conversion circuit is an asynchronous half-bridge flyback power converter.

21. The control method as claimed in claim 12, wherein the power conversion circuit is a resonant power converter.
